(19) United States
(12) Patent Application Publication
(10) Pub. No.: US 2025/0374182 A1
(43) Pub. Date: Dec. 4, 2025

(54) METHOD AND APPARATUS FOR NETWORK POWER REDUCTION MODE OPERATION IN WIRELESS COMMUNICATION SYSTEM

(71) Applicant: Samsung Electronics Co., Ltd., Suwon-si, Gyeonggi-do (KR)

(72) Inventors: Sangkyu BAEK, Suwon-si (KR); Anil AGIWAL, Suwon-si (KR)

(21) Appl. No.: 18/873,541

(22) PCT Filed: Jun. 2, 2023
(86) PCT No.: PCT/KR2023/007561

§ 371 Date: Dec. 10, 2024

(30) Foreign Application Priority Data
Jun. 10, 2022 (KR) 10-2022-0070730

(51) Int. Cl. H04W 52/02; H04W 72/11; H04W 72/231

(52) U.S. Cl. CPC H04W 52/0206; H04W 72/11; H04W 72/231

(57) ABSTRACT

The present disclosure relates to a 5G or 6G communication system for supporting higher data transmission rates. The present disclosure provides an operation method for supporting an energy saving mode of a base station in a wireless communication system, comprising the steps of: receiving, from a base station, a radio resource control (RRC) message including configuration information regarding energy saving of the base station; and performing communication with the base station on the basis of periodic activation or deactivation of the energy saving mode of the base station, which is identified on the basis of the configuration information, and activation or deactivation of the energy saving mode, which is determined on the basis of reception of a mode change indicator received from the base station.

### TECHNICAL FIELD

The disclosure relates to operations of a terminal and a base station in a wireless communication system and, particularly, to a method and a device for an operation in a network power reduction mode.

### BACKGROUND ART

5G mobile communication technologies define broad frequency bands to enable high transmission rates and new services, and can be implemented not only in “Sub 6GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to reduce power consumption of networks.

### DISCLOSURE OF INVENTION

### Technical Problem

The disclosed embodiment is to provide a device and a method capable of effectively providing a service in a wireless communication system.

### Solution to Problem

According an embodiment of the disclosure, an operation method of a terminal supporting an energy saving mode of a base station in a wireless communication system may include: receiving, from the base station, a radio resource control (RRC) message including configuration information regarding energy saving of the base station; and performing communication with the base station, based on periodic activation or deactivation of the energy saving mode of the base station, which is identified based on the configuration information, and activation or deactivation of the energy saving mode, which is determined based on reception of a mode change indicator received from the base station, wherein in case that the energy saving mode of the base station is deactivated, a part of a transmission and reception operation of the terminal is not performed.

In case that the energy saving mode of the base station is deactivated, transmission of an uplink configured grant (CG) of the terminal may not be performed.

In case that the energy saving mode of the base station is deactivated, downlink semi-persistent scheduling (SPS) monitoring of the terminal may not be performed.

The performing of the communication with the base station may include performing monitoring for a predetermined time, based on periodic deactivation of the energy saving mode of the base station, which is identified based on the configuration information.

The mode change indicator received from the base station may include downlink control information (DCI).

According an embodiment of the disclosure, an operation method of a base station operating in an energy saving mode in a wireless communication system may include: transmitting, to a terminal, a radio resource control (RRC) message including configuration information regarding energy saving of the base station; and periodically determining activation or deactivation of the energy saving mode, based on the configuration information, or determining activation or deactivation of the energy saving mode, based on reception of a mode change indicator transmitted to the terminal, wherein in case that the energy saving mode is deactivated, a part of a transmission and reception operation of the base station is not performed.

In case that the energy saving mode of the base station is deactivated, reception of an uplink configured grant (CG) from the terminal may not be performed.

In case that the energy saving mode of the base station is deactivated, downlink semi-persistent scheduling (SPS) transmission to the terminal may not be performed.

The configuration information includes information about a period of time during which monitoring is required to be performed for a predetermined time based on periodic deactivation of the energy saving mode of the base station.

The mode change indicator may include downlink control information (DCI).

According an embodiment of the disclosure, a terminal supporting an energy saving mode of a base station in a wireless communication system may include: a transceiver; and at least one processor coupled to the transceiver, wherein the processor is configured to receive, from the base station, a radio resource control (RRC) message including configuration information regarding energy saving of the base station, perform communication with the base station, based on periodic activation or deactivation of the energy saving mode of the base station, which is identified based on the configuration information, and activation or deactivation of the energy saving mode, which is determined based on reception of a mode change indicator received from the base station, and in case that the energy saving mode of the base station is deactivated, not perform a part of a transmission and reception operation of the terminal.

The at least one processor may be configured to, in case that the energy saving mode of the base station is deactivated, not perform transmission of an uplink configured grant (CG) of the terminal.

The at least one processor may be configured to, in case that the energy saving mode of the base station is deactivated, not perform downlink semi-persistent scheduling (SPS) monitoring of the terminal.

The at least one processor may be configured to perform monitoring for a predetermined time, based on periodic deactivation of the energy saving mode of the base station, which is identified based on the configuration information.

The mode change indicator received from the base station may include downlink control information (DCI).

According an embodiment of the disclosure, a base station operating in an energy saving mode in a wireless communication system may include: a transceiver; and at least one processor coupled to the transceiver.

The at least one processor may be configured to transmit, to a terminal, a radio resource control (RRC) message including configuration information regarding energy saving of the base station, periodically determine activation or deactivation of the energy saving mode, based on the configuration information, or determine activation or deactivation of the energy saving mode, based on reception of a mode change indicator transmitted to the terminal, and in case that the energy saving mode is deactivated, not perform a part of a transmission and reception operation of the base station.

The at least one processor may be configured to, in case that the energy saving mode of the base station is deactivated, not perform reception of an uplink configured grant (CG) from the terminal.

The at least one processor may be configured to, in case that the energy saving mode of the base station is deactivated, not perform downlink semi-persistent scheduling (SPS) transmission to the terminal.

The configuration information may include information about a period of time during which monitoring is required to be performed for a predetermined time based on periodic deactivation of the energy saving mode of the base station.

The mode change indicator may include downlink control information (DCI).

### Advantageous Effects of Invention

The disclosure provides a device and a method capable of effectively providing a service in a wireless communication system.

### BRIEF DESCRIPTION OF DRAWINGS

FIG. 1 illustrates a network power consumption reduction scheme in a wireless communication system according to an embodiment of the disclosure;

FIG. 2 illustrates a network energy (NE) state according to an embodiment of the disclosure;

FIG. 3 illustrates an NE state according to an embodiment of the disclosure;

FIG. 4 illustrates an operation manner of a network energy saving (NES) mode according to an embodiment of the disclosure;

FIG. 5 illustrates an operation manner of an NES mode according to an embodiment of the disclosure;

FIG. 6 illustrates an operation manner of an NES mode according to an embodiment of the disclosure;

FIG. 7 illustrates an operation manner of an NES mode according to an embodiment of the disclosure;

FIG. 8 illustrates an NES bandwidth part (BWP) according to an embodiment of the disclosure;

FIG. 9 illustrates a switching method of an NES BWP according to an embodiment of the disclosure;

FIG. 10 illustrates an NES mode activation MAC CE format according to an embodiment of the disclosure;

FIG. 11 illustrates a manner of configuring an NES mode through group transmission according to an embodiment of the disclosure;

FIG. 12 illustrates a manner of reporting NES mode support capability of a UE according to an embodiment of the disclosure;

FIG. 13 illustrates a manner of configuring an NES mode between base stations according to an embodiment of the disclosure;

FIG. 14 illustrates a manner of configuring an NES mode in a communication network according to an embodiment of the disclosure;

FIG. 15 illustrates a structure of a base station according to an embodiment of the disclosure; and

FIG. 16 illustrates a structure of a UE according to an embodiment of the disclosure.

### MODE FOR THE INVENTION

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. Hereinafter, the operation principle of the disclosure will be described in detail in conjunction with the accompanying drawings.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3rd generation partnership project long term evolution (3GPP LTE) standards will be used for the sake of descriptive convenience. However, the disclosure is not limited by these terms and names, and may be applied in the same way to systems that conform other standards.

In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHZ or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and may also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

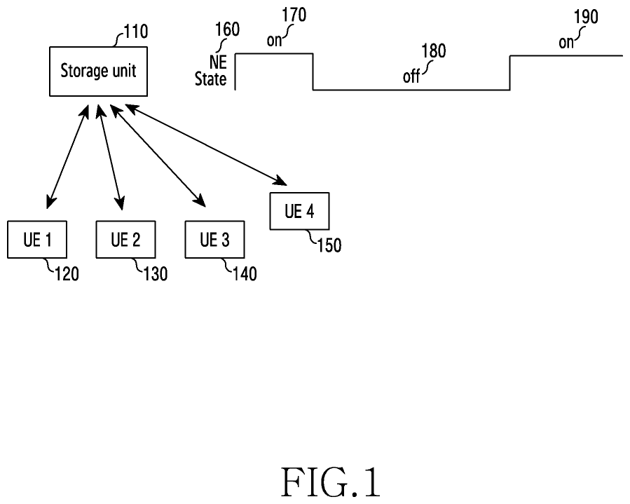

FIG. 1 illustrates a network power consumption reduction scheme in a mobile communication system according to an embodiment of the disclosure.

In a wireless communication system, a base station 110 provides a communication service to multiple UEs 120, 130, 140, and 150. In this case, each of the UEs 120, 130, 140, and 150 may be in a connected mode (RRC_CONNECTED mode) in which a radio resource control (RRC) connection is established, an inactive mode (RRC_INACTIVE mode) in which an RRC connection is released, or an idle mode (RRC_IDLE mode). The UEs in various RRC modes may be located in a coverage of one base station, and the base station 110 may provide a communication service to the multiple UEs 120, 130, 140, and 150. Therefore, the base station 110 may have relatively high power consumption compared to the UEs. In addition, a 5th generation (5G) mobile communication system that requires high-speed transmission is required to have a higher bandwidth, a higher transmission signal strength, and higher reception sensitivity for high-speed transmission, which leads to high power consumption. Since the number of base stations managed by one mobile communication service provider ranges from tens of thousands to hundreds of thousands, high power consumption of a communication network including a base station may increase management and maintenance costs of a mobile communication network. Therefore, a method for reducing power consumption of a communication network is required.

A reduction in power consumption in a communication network can be achieved by the base station 110 temporarily cutting off a power source of a transceiver. Temporary cutoff of the power source of the transceiver of the base station 110 is possible only when communication with a UE to which the base station 110 is required to provide a communication service is not performed. Referring to FIG. 1, a state of whether the base station 110 has cut off the power source of the transceiver is represented as a network energy (NE) state 160. When the NE state of the base station 110 is ON 170, the base station 110 may perform a procedure necessary for transmission or reception with the UE while keeping the power source of the transceiver turned on. For example, the base station 110 may indicate resource allocation information on a physical downlink control channel (PDCCH) to allocate a downlink resource to the UE, and perform data transmission on a physical downlink shared channel (PDSCH). However, when the base station 110 has little or no data to transmit or receive with the UE, the base station 110 may switch the NE state to be OFF 180 and cut off the power source of the transceiver. In this case, when the UE is aware of the NE state of the base station 110, the UE may also cut off a power source of a transceiver of the UE to reduce power consumption, and may not perform an unnecessary communication procedure. The transition of the NE state of the base station 110 may occur for a predefined time or may be changed by separate control information. The NE state 160 of FIG. 1 shows switching back to an ON state 190 after a configured OFF state time.

The base station 110 may also cut off power sources of all transceivers in the NE OFF state 180, but in some embodiments, a part of a transmission and reception function of the base station 110 may be deactivated to achieve a partial reduction in power consumption. According to an embodiment, the base station 110 may periodically deactivate transmission of downlink semi-persistent scheduling (SPS) transmitted by the base station to the UE. In addition, according to an embodiment, transmission of an uplink configured grant (CG) transmitted by the UE to the base station 110 may be deactivated so that the base station 110 does not receive a CG in the NE OFF state. The base station 110 transmits, to the UE, information on whether to deactivate a part of a transmission and reception function, and the UE does not perform an operation corresponding to a function deactivated by the base station 110, so that the UE can also reduce unnecessary power consumption and prevent malfunction of the UE. An operation mode of the base station 110 and the UE for the NE OFF state of the base station 110 may be referred to as a network energy saving (NES) mode. In an embodiment, only the NE OFF state of the base station may be referred to as an NES mode. Although the detailed definition of the NES mode may vary according to an embodiment, performing a separate operation by the base station 110 and the UE to reduce power consumption of the base station 110 may be comprehensively referred to as an NES mode.

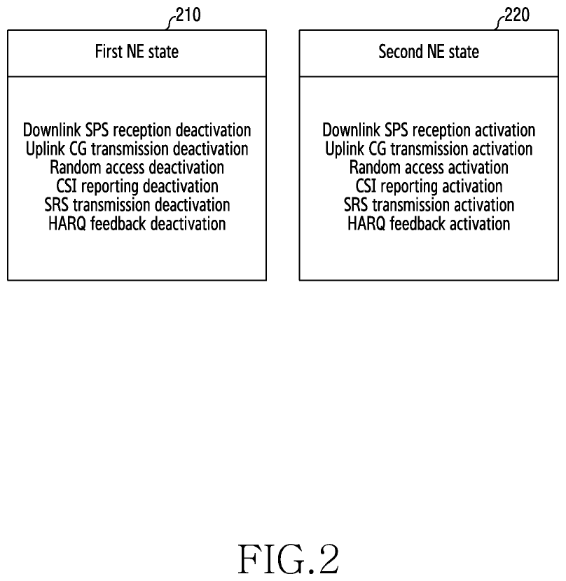

FIG. 2 illustrates an NE state according to an embodiment of the disclosure.

A reduction in power consumption in a communication network can be achieved by a base station temporarily cutting off a power source of a transceiver. Temporary cutoff of the power source of the transceiver of the base station is possible only when communication with a UE to which the base station is required to provide a communication service is not performed. The embodiment of FIG. 2 shows that the base station has two network energy (NE) states depending on whether the base station has cut off the power source of the transceiver. Referring to FIG. 2, the two NE states are referred to as a first NE state 210 and a second NE state 220, respectively, but specific names may vary according to an embodiment.

The first NE state 210 may indicate a state in which the base station temporarily cuts off the power source of the transceiver. When the power source of the transceiver of the base station is temporarily cut off, the base station cannot perform data transmission and reception. When transmission from the base station is not expected, the UE does not need to receive data transmitted by the base station, conversely, when reception by the base station is not expected, the UE does not need to transmit data to the base station. To this end, in the first NE state 210, the UE may perform at least one of the following operations.
The UE deactivates reception of downlink semi-persistent scheduling (SPS) configured in the UE (downlink)
The UE deactivates transmission of an uplink configured grant (CG) configured in the UE (uplink)
The UE deactivates a random access channel operation and does not perform the same (uplink)
The UE deactivates channel state indicator (CSI) reporting and does not perform the same (uplink)
The UE deactivates sounding reference signal (SRS) reporting and does not perform the same (uplink)
The UE deactivates a hybrid automatic repeat request (HARQ) feedback and does not perform the same (uplink)

The base station may configure, for the UE, when the UE should be in the first NE state 210, through one of a radio resource control (RRC) message, a medium access control-control element (MAC CE), and a downlink control information (DCI) message. In an embodiment, the base station may configure, for the UE, one or more of deactivation operations in the first NE state 210 through at least one message. In another embodiment, the base station may separately deactivate an uplink operation or a downlink operation for the UE.

When the UE in the first NE state 210 performs the above-described operation, the base station may perform at least one of the following operations.
The base station deactivates transmission of downlink semi-persistent scheduling (SPS) configured in the UE (downlink)
The base station deactivates reception of an uplink configured grant (CG) configured in the UE (uplink)
The UE deactivates a random access channel operation and the base station does not receive a random access preamble (uplink)
The base station deactivates channel state indicator (CSI) reporting and does not receive the same (uplink)
The base station deactivates sounding reference signal (SRS) reporting and does not receive the same (uplink)
The base station deactivates a hybrid automatic repeat request (HARQ) feedback and does not receive the same (uplink)

The second NE state 220 may indicate a state in which the base station performs normal transmission and reception without cutting off the power source of the transceiver. When transmission from the base station is expected, the UE is required to receive data transmitted by the base station, conversely, when reception by the base station is expected, the UE is required to transmit data to the base station. To this end, in the second NE state 220, the UE may perform at least one of the following operations.
The UE activates reception of downlink semi-persistent scheduling (SPS) configured in the UE (downlink)
The UE activates transmission of an uplink configured grant (CG) configured in the UE (uplink)
The UE activates and performs a random access channel operation (uplink)
The UE activates and performs channel state indicator (CSI) reporting (uplink)
The UE activates and performs sounding reference signal (SRS) reporting (uplink)
The UE activates and performs a hybrid automatic repeat request (HARQ) feedback (uplink)

The base station may configure, for the UE, when the UE should be in the second NE state 220, through one of a radio resource control (RRC) message, a medium access control-control element (MAC CE), and a downlink control information (DCI) message. In an embodiment, the base station may configure one or more of activation operations in the second NE state 220 through at least one message. In another embodiment, the base station may separately activate an uplink operation or a downlink operation for the UE.

When the UE in the second NE state 220 performs the above-described operation, the base station may perform at least one of the following operations.
The base station activates transmission of downlink semi-persistent scheduling (SPS) configured in the UE (downlink)
The base station activates reception of an uplink configured grant (CG) configured in the UE (uplink)
The UE activates a random access channel operation and the base station receives a random access preamble (uplink)
The base station activates and receives channel state indicator (CSI) reporting (uplink)
The base station activates and receives sounding reference signal (SRS) reporting (uplink)
The base station activates and receives a hybrid automatic repeat request (HARQ) feedback (uplink)

In an embodiment, a manner in which the UE performs an operation of transitioning between the first NE state 210 and the second NE state 220 may be defined as an NES mode. However, in another embodiment, only a manner in which the UE performs an operation of the first state 210 may also be defined as an NES mode. In addition, in an embodiment, the first NE state 210 may also be defined as an NE ON state, and the second NE state 220 may also be defined as an NE OFF state. That is, there is no limitation on the definition of an NES mode.

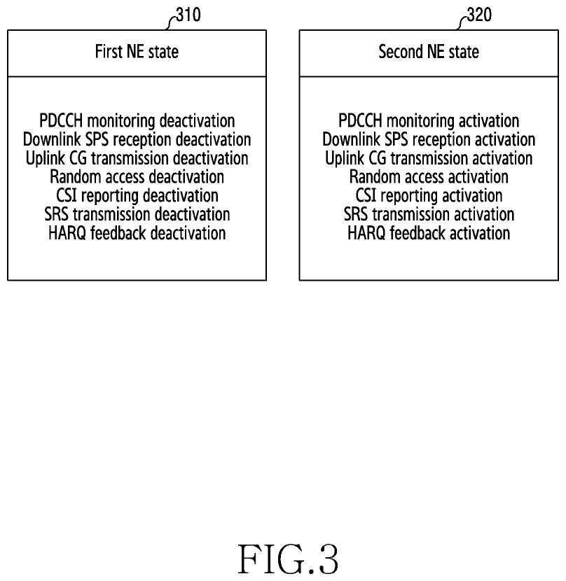

FIG. 3 illustrates an NE state according to an embodiment of the disclosure.

A reduction in power consumption in a communication network can be achieved by a base station temporarily cutting off a power source of a transceiver. Temporary cutoff of the power source of the transceiver of the base station is possible only when communication with a UE to which the base station is required to provide a communication service is not performed. The embodiment of FIG. 3 shows that the base station has two network energy (NE) states depending on whether the base station has cut off the power source of the transceiver. Referring to FIG. 3, the two NE states are referred to as a first NE state 310 and a second NE state 320, respectively, but specific names may vary according to an embodiment.

The first NE state 310 may indicate a state in which the base station temporarily cuts off the power source of the transceiver. When the power source of the transceiver of the base station is temporarily cut off, the base station cannot perform data transmission and reception. When transmission from the base station is not expected, the UE does not need to receive data transmitted by the base station, conversely, when reception by the base station is not expected, the UE does not need to transmit data to the base station. In addition, the base station cannot perform radio resource allocation using a physical downlink control channel (PDCCH). If the base station does not perform the radio resource allocation using the PDCCH, the UE does not need to perform PDCCH monitoring. To this end, in the first NE state 310, the UE may perform at least one of the following operations.
The UE deactivates PDCCH monitoring of the UE and does not perform the same (downlink)
The UE deactivates reception of downlink semi-persistent scheduling (SPS) configured in the UE (downlink)
The UE deactivates transmission of an uplink configured grant (CG) configured in the UE (uplink)
The UE deactivates a random access channel operation and does not perform the same (uplink)
The UE deactivates channel state indicator (CSI) reporting and does not perform the same (uplink)
The UE deactivates sounding reference signal (SRS) reporting and does not perform the same (uplink)
The UE deactivates a hybrid automatic repeat request (HARQ) feedback and does not perform the same (uplink)

The base station may configure, for the UE, when the UE should be in the first NE state 310, through one of a radio resource control (RRC) message, a medium access control-control element (MAC CE), and a downlink control information (DCI) message. In an embodiment, the base station may configure, for the UE, one or more of deactivation operations in the first NE state 310 through at least one message. In another embodiment, the base station may separately deactivate an uplink operation or a downlink operation for the UE.

When the UE in the first NE state 310 performs the above-described operation, the base station may perform at least one of the following operations.
The base station does not perform resource allocation using a PDCCH for the UE (downlink)
The base station deactivates transmission of downlink semi-persistent scheduling (SPS) configured in the UE (downlink)
The base station deactivates reception of an uplink configured grant (CG) configured in the UE (uplink)
The UE deactivates a random access channel operation and the base station does not receive a random access preamble (uplink)
The base station deactivates channel state indicator (CSI) reporting and does not receive the same (uplink)
The base station deactivates sounding reference signal (SRS) reporting and does not receive the same (uplink)
The base station deactivates a hybrid automatic repeat request (HARQ) feedback and does not receive the same (uplink)

The second NE state 320 may indicate a state in which the base station performs normal transmission and reception without cutting off the power source of the transceiver. When transmission from the base station is expected, the UE is required to receive data transmitted by the base station, conversely, when reception by the base station is expected, the UE is required to transmit data to the base station. To this end, in the second NE state 220, the UE may perform at least one of the following operations.
The UE activates and performs PDCCH monitoring of the UE (downlink)
The UE activates reception of downlink semi-persistent scheduling (SPS) configured in the UE (downlink)
The UE activates transmission of an uplink configured grant (CG) configured in the UE (uplink)
The UE activates and performs a random access channel operation (uplink)
The UE activates and performs channel state indicator (CSI) reporting (uplink)
The UE activates and performs sounding reference signal (SRS) reporting (uplink)
The UE activates and performs a hybrid automatic repeat request (HARQ) feedback (uplink)

The base station may configure, for the UE, when the UE should be in the second NE state 320, through one of a radio resource control (RRC) message, a medium access control-control element (MAC CE), and a downlink control information (DCI) message. In an embodiment, the base station may configure one or more of activation operations in the second NE state 320 through at least one message. In another embodiment, the base station may separately activate an uplink operation or a downlink operation for the UE.

When the UE in the second NE state 320 performs the above-described operation, the base station may perform at least one of the following operations.
The base station performs resource allocation using a PDCCH for the UE (downlink)
The base station activates transmission of downlink semi-persistent scheduling (SPS) configured in the UE (downlink)
The base station activates reception of an uplink configured grant (CG) configured in the UE (uplink)
The UE activates a random access channel operation and the base station receives a random access preamble (uplink)
The base station activates and receives channel state indicator (CSI) reporting (uplink)
The base station activates and receives sounding reference signal (SRS) reporting (uplink)
The base station activates and receives a hybrid automatic repeat request (HARQ) feedback (uplink)

In an embodiment, a manner in which the UE performs an operation of transitioning between the first NE state 310 and the second NE state 320 may be defined as an NES mode. However, in another embodiment, only a manner in which the UE performs an operation of the first state 310 may also be defined as an NES mode. In addition, in an embodiment, the first NE state 310 may also be defined as an NE ON state, and the second NE state 320 may also be defined as an NE OFF state. That is, there is no limitation on the definition of an NES mode.

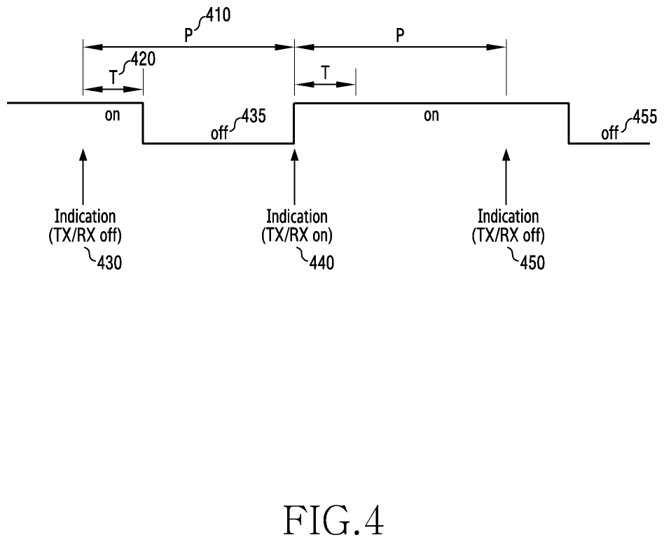

FIG. 4 illustrates an operation manner of an NES mode according to an embodiment of the disclosure.

In an NES mode defined to reduce power consumption of a base station, a UE may operate in a manner of periodically transitioning between a first NE state (NE OFF) and a second NE state (NE ON) described in FIG. 2 or FIG. 3. Depending on an NE state of the UE, the base station may temporarily cut off a power source of a transceiver to obtain a power consumption reduction effect. This NES mode may be configured by the base station for the UE through an RRC message.

In the embodiment of FIG. 4, the UE configured in the NES mode may periodically identify (or monitor) indicators 430, 440, and 450 of the base station in the second NE state to determine whether the UE is to transition to the first NE state (NE OFF). In the embodiment of FIG. 4, it is assumed that a period for transitioning to the second NE state by the UE to identify an indicator of the base station is P 410, and a time for transitioning to the second NE state to identify an indicator of the base station is T 420. Values of P and T may be configured by being transmitted from the base station to the UE through an RRC message or an MAC CE.

In an embodiment, the values of P and T may be preconfigured values. When the UE transitions to the first NE state at time T, the base station may indicate, to the UE, whether the UE is to transition to the first NE state or be in the second NE state after time T (430, 440, 450). Based on the above, the UE may determine an NE state.

In the embodiment of FIG. 4, it is assumed that the UE receives, from the base station, an indication 430 to transition from the second NE state to the first NE state (TX/RX OFF and NE OFF) at time point T. Thereafter, the UE may transition (435) to the first NE state at the end of time T. However, in another embodiment, the UE may transition to the first NE state immediately (or after a predetermined time) upon receiving an indication to transition to the first NE state from the base station.

In addition, in an embodiment, an indicator 440 indicating the UE to transition to the first NE state may be omitted, and the UE may transition to the first NE state even without receiving this indicator. Thereafter, at a start time point of next period P, the UE may transition to the first NE state during time T to identify an indicator of the base station.

In the embodiment of FIG. 4, in this case, it is assumed that the UE is indicated (440) to maintain the second NE state. Thereafter, the UE does not transition to the first NE state during the corresponding time P. In an embodiment, an indicator indicating the UE to maintain the second NE state may be omitted, and the UE may maintain the second NE state even when the UE does not receive the indicator indicating the UE to maintain the second NE state. Thereafter, at a start time point of period P, the UE may identify an indicator of the base station in the second state during time T. In the embodiment of FIG. 4, in this case, it is assumed that the UE is indicated (450) to transition to the first NE state. Thereafter, the UE may transition (455) to the first NE state at the end of time T. However, in an embodiment, the UE may transition to the first NE state immediately (or after a predetermined time) upon receiving an indication to transition to the first NE state from the base station.

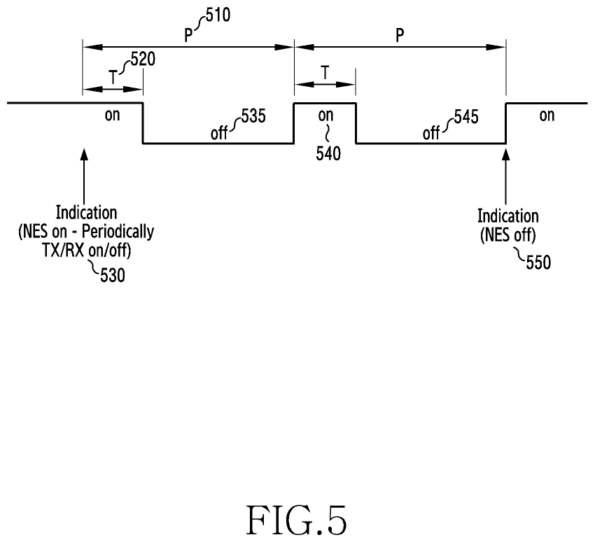

FIG. 5 illustrates an operation manner of an NES mode according to an embodiment of the disclosure.

In an NES mode defined to reduce power consumption of a base station, a UE may operate in a manner of periodically transitioning between a first NE state (NE OFF) and a second NE state (NE ON) described in FIG. 2 or FIG. 3. Depending on an NE state of the UE, the base station may temporarily cut off a power source of a transceiver to obtain a power consumption reduction effect. The NES mode may be configured by the base station for the UE through an RRC message. In the embodiment of FIG. 5, the UE configured in the NES mode identifies (or monitors) indicators 530 and 550 of the base station in the second NE state to determine whether the UE is to transition to the first NE state (NE OFF), and the UE periodically transitions between the first NE state and the second NE state. In the embodiment of FIG. 5, it is assumed that a period for transitioning to the second NE state by the UE to identify an indicator of the base station is P 510, and a time for transitioning to the second NE state to identify an indicator of the base station is T 520. Values of P and T may be configured by being transmitted from the base station to the UE through an RRC message or an MAC CE.

In an embodiment, the values of P and T may be preconfigured values. The base station may transmit an indicator 530 indicating the UE to periodically transition to the first NE state when the UE is in the second NE state. Thereafter, the UE having received the indicator 530 indicating the UE to transition to the first NE state may perform an operation of transitioning to the second NE state during time T in every period P. Thereafter, the UE may transition (535) to the first NE state at the end of time T. However, in an embodiment, the UE may transition to the first NE state immediately (or after a predetermined time) upon receiving an indication to transition to the first NE state from the base station.

Thereafter, at a start time point of next period P, the UE may transition to the second NE state during time T to identify (540) an indicator of the base station. In the embodiment of FIG. 5, in this case, it is assumed that the UE does not receive a separate indicator. When the UE does not receive a separate indicator, the UE may transition (545) back to the first NE state after time T. Thereafter, at a start time point of period P, the UE may identify an indicator of the base station in the second NE state during time T. In the embodiment of FIG. 5, in this case, it is assumed that the UE receives, from the base station, an indication (550) indicating the UE to maintain the second NE state without transitioning to the first NE state any longer. Thereafter, the UE may maintain the second NE state.

In some embodiments, NES mode information such as P and T values may be configured by the base station for the UE through an RRC message, but an indicator indicating the UE to activate (NES on) (530) or deactivate (NES off) (550) the NES mode may be dynamically configured by an MAC CE or DCI. The disclosure is not limited to the above example.

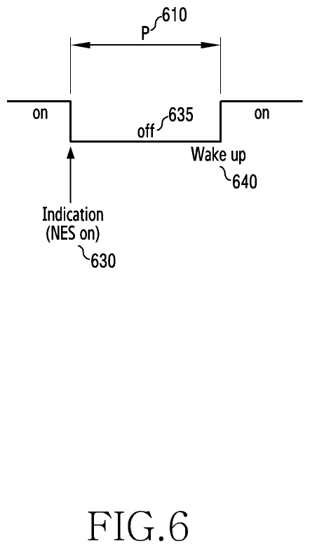

FIG. 6 illustrates an operation manner of an NES mode according to an embodiment of the disclosure.

In an NES mode defined to reduce power consumption of a base station, a UE may operate in a manner of periodically transitioning between a first NE state (NE OFF) and a second NE state (NE ON) described in FIG. 2 or FIG. 3. Depending on an NE state of the UE, the base station may temporarily cut off a power source of a transceiver to obtain a power consumption reduction effect. This NES mode may be configured by the base station for the UE through an RRC message.

In the embodiment of FIG. 6, the UE configured in the NES mode identifies an indicator 630 of the base station in the second NE state to determine whether the UE is to transition to the second NE state (NE OFF). When the UE in the second NE state receives, from the base station, the indicator 630 indicating the UE to transition to the first NE state, the UE may transition (635) to the first NE state during configured time P 610. A value of P may be configured by being transmitted from the base station through an RRC message, MAC CE, or DCI.

In an embodiment, the value of P may be a preconfigured value. In the embodiment of FIG. 6, transitioning to the first NE state may be defined as an NES ON state. After time P has elapsed, the UE may transition to a second NE state 640. In this case, the UE may monitor whether an indicator indicating the UE to transition to the first NE state is received from the base station. In an embodiment, NES mode information such as P may be configured by the base station for the UE through an RRC message, but an indicator indicating the UE to activate (NES ON) (630) the NES mode may be dynamically configured by an MAC CE or DCI. The disclosure is not limited to the above example.

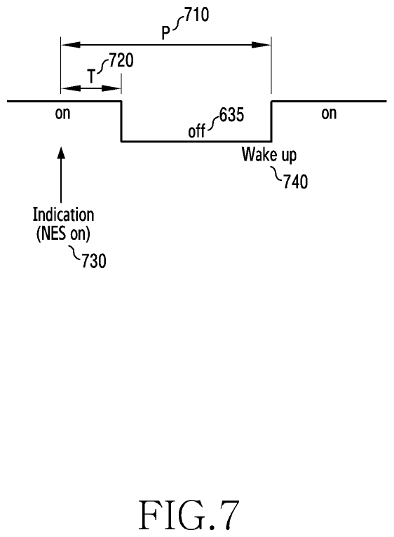

FIG. 7 illustrates an operation manner of an NES mode according to an embodiment of the disclosure.

In an NES mode defined to reduce power consumption of a base station, a UE may operate in a manner of periodically transitioning between a first NE state (NE OFF) and a second NE state (NE ON) described in FIG. 2 or FIG. 3. Depending on an NE state of the UE, the base station may temporarily cut off a power source of a transceiver to obtain a power consumption reduction effect. According to an embodiment, the NES mode may be configured by the base station for the UE through an RRC message.

In the embodiment of FIG. 7, the UE configured in the NES mode identifies an indicator 730 of the base station in the second NE state to determine whether the UE is to transition to the second NE state (NE OFF). When the UE in the second NE state receives, from the base station, the indicator 730 indicating the UE to transition to the first NE state, the UE may transition (735) to the first NE state during configured time P 710 after predetermined time T 720. Values of T and P may be configured by being transmitted from the base station through an RRC message, an MAC CE, or DCI.

In an embodiment, the values of T and P may be preconfigured values. In the embodiment of FIG. 7, transitioning to the first NE state may be defined as an NES ON state. After time P has elapsed, the UE may transition (740) to the second NE state. In this case, the UE may monitor whether an indicator indicating the UE to transition to the first NE state is received from the base station. In an embodiment, NES mode information such as T and P may be configured by the base station for the UE through an RRC message, but an indicator indicating the UE to activate (NES ON) (730) the NES mode may be dynamically configured by an MAC CE or DCI. The disclosure is not limited to the above example.

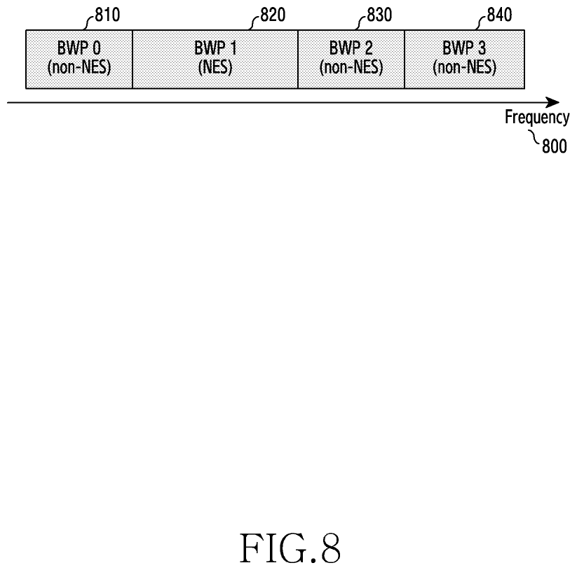

FIG. 8 illustrates an NES BWP according to an embodiment of the disclosure.

In order to reduce power consumption of a base station, the base station may cut off power sources of some transceivers, but cutting off a power source of a transceiver for a specific frequency in a frequency axis 800 may help in efficient use of a radio resource and the power consumption efficiency. To this end, an NES mode may be applied for each bandwidth part (BWP) in the frequency axis. In the embodiment of FIG. 8, it is assumed that a total of four BWPs such as BWP0 810, BWP1 820, BWP2 830, and BWP3 840 are configured, and BWP1 820 among the BWPs is configured as an NES BWP. The remaining non-NES BWPs (BWP0, BWP2, and BWP3) are BWPs in which a second NE state is maintained without applying the NES mode, while in the NES BWP (BWP1), the UE may perform an operation of transitioning between a first NE state and the second NE state. The operation of transitioning between the first NE state and the second NE state may be one of the methods described in FIGS. 4, 5, 6, and 7. NES BWP information may be configured by the base station through an RRC message. The NES BWP information is not limited to the above example, and may be configured through an MAC CE or DCI, or may be configured through another message.

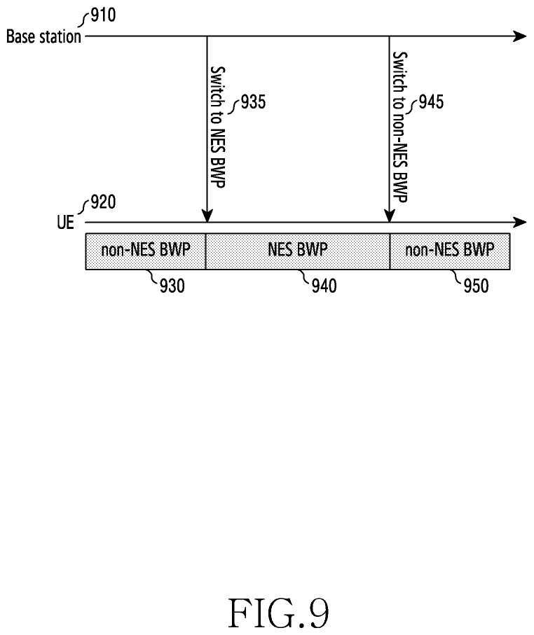

FIG. 9 illustrates a switching method of an NES BWP according to an embodiment of the disclosure.

In order to reduce power consumption of a base station, the base station may cut off power sources of some transceivers, but cutting off a power source of a transceiver for a specific frequency in a frequency axis may help in efficient use of a radio resource and the power consumption efficiency. To this end, an NES mode may be applied for each bandwidth part (BWP) in the frequency axis. As described in FIG. 8, a BWP in which a second NE state is maintained may be referred to as a non-NES BWP, and a BWP in which the UE performs an operation of transitioning between a first NE state and the second NE state may be referred to as an NES BWP. When the UE does not require high-speed data transmission or the UE may receive a normal service even in the case of the NES mode operation of the base station, the UE may switch to the NES BWP. To this end, a base station 910 may configure an NES BWP 930 for a UE 920 and indicate (935) the UE to switch to the NES BWP. In the embodiment of FIG. 9, it is assumed that the UE in the non-NES BWP receives an indication (935) to switch to the NES BWP from the base station. Thereafter, the UE switches to an NES BWP 940 and performs an operation of the NES BWP. Thereafter, as necessary, the base station may indicate the UE to switch to the non-NES BWP (945), and the UE may switch to a non-NES BWP 950. Switching to the NES BWP may be indicated in the format of an MAC CE or DCI. In this case, information on whether a BWP to be switched is an NES BWP may be displayed separately. NES BWP information may be configured by the base station through an RRC message. The NES BWP information is not limited to the above example, and may be configured through an MAC CE or DCI, or may be configured through another message.

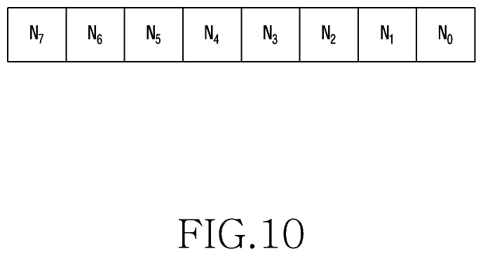

FIG. 10 illustrates an NES mode activation MAC CE format according to an embodiment of the disclosure.

The transition between a first NE state and a second NE state of a UE according to the cutoff of a power source of a transceiver of a base station may be configured and operated for each configured cell of the UE. In other words, an NES mode of the UE may be configured and activated for each cell. To this end, the base station may indicate the UE to activate an NES mode for each cell in an MAC CE format.

In the embodiment of FIG. 10, it is assumed that the base station indicates NES mode activation in the MAC CE format including a bitmap. In the embodiment of FIG. 10, an 8-bit length message is assumed, but the actual number of bits may vary according to an embodiment. Each Ni bit (i=0, 1, 2, 3, 4, 5, 6, 7) of an MAC CE may indicate whether the NES mode is activated in a cell of index i. Specifically, when a value of an Ni bit is 1, activation of the NES mode may be indicated, and when the value of the Ni bit is 0, deactivation of the NES mode (or the NES mode is not activated) may be indicated. An index i value of Ni may use a cell index value. The disclosure is not limited to the above example, and the base station may define an index i value of the MAC CE for activation of the NES mode as a separate index value corresponding to one cell and configure the value for the UE through an RRC message.

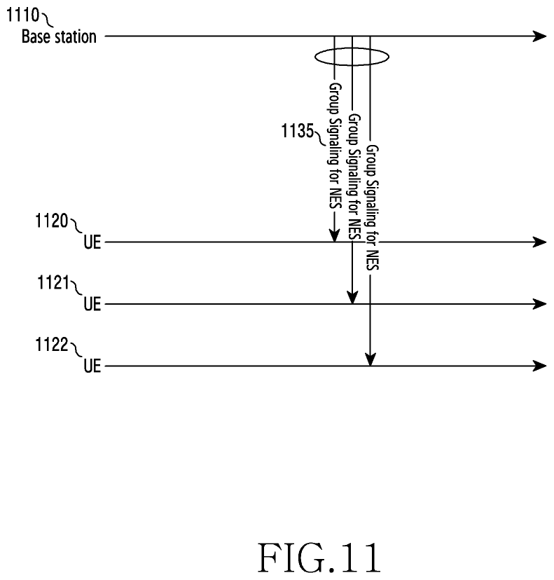

FIG. 11 illustrates a manner of configuring an NES mode through group transmission according to an embodiment of the disclosure.

Since a base station generally provides a communication service to multiple UEs, when the multiple UEs connected to a cell (or BWP) operated by the base station are configured in an NES mode, a power source of a transceiver may be cut off to reduce power consumption. Therefore, configuring the NES mode for the UE by the base station may be performed for the multiple UEs at the same time point or at a similar time point (within a predetermined period of time from a predetermined time point).

Therefore, the base station may transmit an indication to configure or activate the NES mode to the multiple UEs in a multicast or broadcast format.

The embodiment of FIG. 11 shows that a base station 1110 performs group transmission 1135 to configure an NES mode to multiple UEs 1120, 1121, and 1222 connected to the base station. A group transmission manner may be transmission through a system information block (SIB) or a group radio network temporary identifier (RNTI) commonly assigned to the multiple UEs. The UEs connected to the base station may operate in the NES mode by receiving a configuration of the NES mode through group transmission and then applying the configuration of the NES mode. According to an embodiment, operating in the NES mode may refer to an operation in which the UE transitions between the first NE state and the second NE state described above according to a rule.

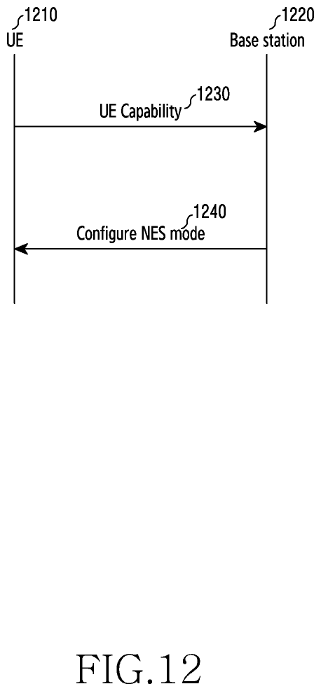

FIG. 12 illustrates a manner of reporting NES mode support capability of a UE according to an embodiment of the disclosure.

When a UE 1210 supports an NES mode, the UE may operate in the NES mode to help reduce power consumption of a base station. However, since configuring (1240) of the NES mode is a configuration by a base station 1220 for the UE, the UE 1210 may be required to report to the base station 1220 whether the UE 1210 is the UE 1210 that supports the NES mode. To this end, the UE may transmit a user equipment (UE) capability message 1230 to the base station. The UE capability message 1230 may include information on whether the UE supports the NES mode, and on a function described in FIG. 2 or 3 which may be deactivated in a first NE state. Based on the UE capability message 1230, the base station 1220 may configure the NES mode for the UE 1210, and the base station may perform an operation of reducing power consumption.

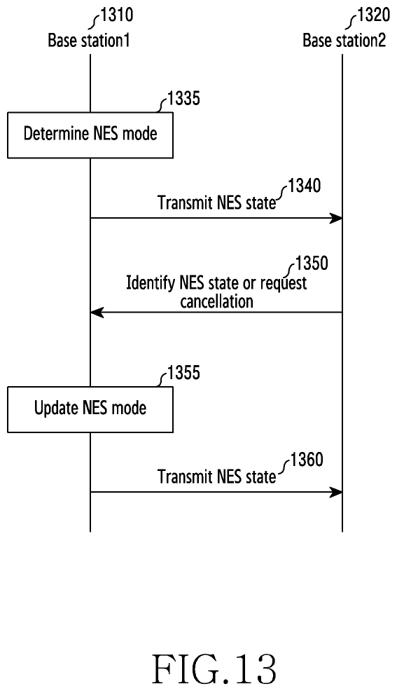

FIG. 13 illustrates a manner of configuring an NES mode between base stations according to an embodiment of the disclosure.

A base station may reduce power consumption of the base station by configuring an NES mode according to a status of a UE connected to the base station, but when one base station configures the NES mode, another base station may be required to process more UEs or maintain a higher transmission speed. Therefore, since an operation of the base station in the NES mode may cause an overload of a neighboring base station, the base station may be required to negotiate NES mode configuration information with the neighboring base station.

In the embodiment of FIG. 13, after a first base station 1310 determines (1335) to configure an NES mode, the first base station may transmit (1340) a state (detailed configuration information or the fact that the NES mode is to be configured) of the NES mode to be configured to a second base station 1320 which is a neighboring base station. The second base station 1320 having received a message regarding the state of the NES mode may determine whether there is no problem in providing a communication service of the second base station due to the NES mode of the first base station 1310.

When the second base station 1320 determines that there is no problem due to the NES mode of the first base station 1310, the second base station 1320 may transmit, to the first base station 1310, a message including information that there is no problem with the NES state of the first base station 1310. When it is determined that the NES mode of the first base station 1310 may cause a problem in providing the communication service of the second base station 1320, the second base station 1320 may send an NES state cancellation request to the first base station 1310 to request no application of the NES mode. That is, the second base station 1320 may transmit feedback information 1350 to the first base station 1310. The first base station 1310 may receive feedback 1350 on an NES state configuration of the first base station 1310 from the second base station 1320, and then update (1355) the NES mode 1355, based on the feedback. Thereafter, the updated NES mode state of the first base station may be transmitted (1360) to the neighboring base station.

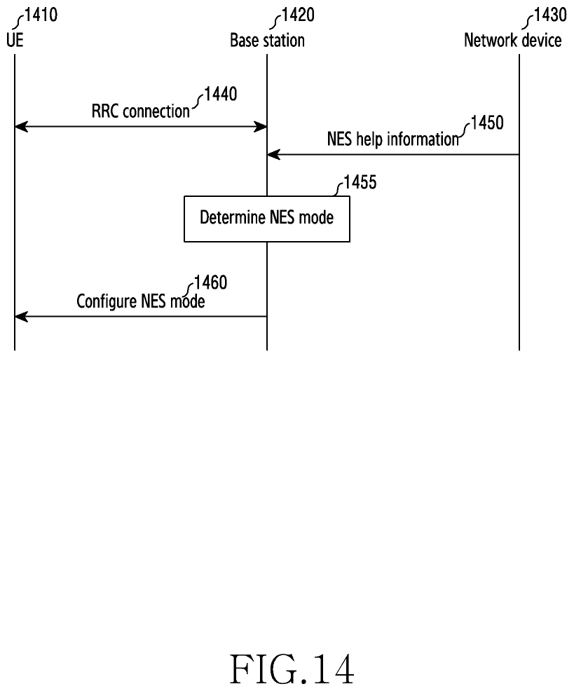

FIG. 14 illustrates a manner of configuring an NES mode in a communication network according to an embodiment of the disclosure.

An NES mode in which a base station cuts off a transmission and reception power source of the base station while transitioning between a first NE state and a second NE state helps reduce power consumption of the base station, but there is a concern that the quality of a communication service of a UE may be degraded since the UE cannot perform a transmission and reception function in the first NE state. Therefore, it is difficult to perform the NES mode in an environment where a base station 1420 performs high-speed transmission to a connected UE 1410 or processes multiple UEs, or a communication service required by the UE requires a short delay time. In addition, in an embodiment, the base station may have a low level of power consumption reduction effect by having a short time in the first NE state (NE OFF).

In the embodiment of FIG. 14, it is assumed that the UE 1410 is connected to the base station 1420 in an RRC connected mode 1440. The base station 1420 may configure an NES mode to reduce power consumption of the base station, but it may be difficult to determine whether the NES mode may be configured by considering the quality of a service that the base station 1420 is required to provide to the UE. To this end, at least one network device 1430 within a communication network may transmit an NES help information message 1450 for the NES mode to the base station. The NES help information message 1450 may include one or more pieces of information among a requirement for a service required to be provided to the UE 1410 connected to the base station 1420, a downlink traffic pattern (a packet period, a transmission speed, etc.) that the base station is required to transmit, an uplink traffic pattern that the base station is required to transmit, NES mode configuration information that the base station may configure, period P of an NES mode that the base station may configure, and whether the base station may apply an NES mode. The NES help information message 1450 may be transmitted to the base station 1420 from one network device 1430 (hereinafter, interchangeably referred to as a network entity or a network function) within a core network. Based on this, the base station 1420 may determine (1455) the NES mode and configure (1460) the NES mode for the UE 1410.

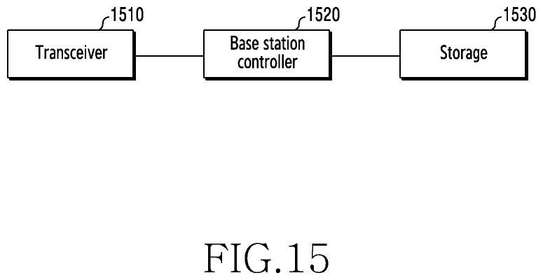

FIG. 15 illustrates a structure of a base station according to an embodiment of the disclosure.

Referring to FIG. 15, the base station may include a transceiver 1510, a controller 1520, and a storage 1530. The transceiver 1510, the controller 1520, and the storage 1530 may be operated according to the above-described communication methods of the base station. In addition, network devices may correspond to the structure of the base station. However, components of the base station are not limited to the above-described example. For example, the base station may include a larger or smaller number of components than the above-described components. Furthermore, the transceiver 1510, the controller 1520y, and the storage 1530 may be implemented in the form of a single chip.

The transceiver 1510 refers to a base station receiver and a base station transmitter as a whole, and may transmit/receive signals with the UE, other base stations, and other network devices. The transmitted/received signals may include control information and data. The transceiver 1510 may transmit, for example, system information, synchronization signals, or reference signals to the UE. To this end, the transceiver 1510 may include an RF transmitter configured to up-convert and amplify the frequency of transmitted signals, an RF receiver configured to low-noise-amplify received signals and down-convert the frequency thereof, and the like. However, this is only an embodiment of the transceiver 1510, and the components of the transceiver 1510 are not limited to the RF transmitter and the RF receiver. The transceiver 1510 may include wired/wireless transceivers, and may various components for transmitting/receiving signals. In addition, the transceiver 1510 may receive signals through a communication channel (e.g., a radio channel), output the same to the controller 1520, and transmit signals output from the controller 1520 through the communication channel. Furthermore, the transceiver 1510 may receive communication signals, output same to a processor, and transmit signals output from the processor to the UE, other base stations, or other network entities through a wired/wireless network.

The storage 1530 may store programs and data necessary for operations of the base station. In addition, the storage 1530 may store control information or data included in signals acquired by the base station. The storage 1530 may include storage media such as a ROM, a RAM, a hard disk, a CD-ROM, and a DVD, or a combination of storage media. In addition, the storage 1530 may store at least one of information transmitted/received through the transceiver 1510 and information generated through the controller 1520.

As used herein, the controller 1520 may be defined as a circuit, an application specific integrated circuit, or at least one processor. The processor may include a communication processor (CP) which performs control for communication and an application processor (AP) which controls upper layers such as application programs. The controller 1520 may control the overall operation of the base station according to the embodiments proposed in the disclosure. For example, the controller 1520 may control signal flows between the respective blocks to perform operations according to the above-described flowcharts.

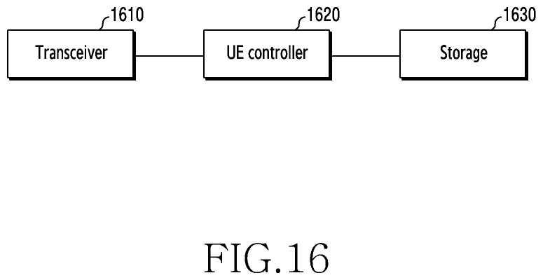

FIG. 16 illustrates a structure of a UE according to an embodiment of the disclosure.

Referring to FIG. 16, the UE may include a transceiver 1610, a controller 1620, and a storage 1630. The transceiver 1610, the controller 1620, and the storage 1630 may be operated according to the above-described communication methods of the UE. However, components of the UE are not limited to the above-described example. For example, the UE may include a larger or smaller number of components than the above-described components. Furthermore, the transceiver 1610, the controller 1620, and the storage 1630 may be implemented in the form of a single chip.

The transceiver 1610 refers to a UE receiver and a UE transmitter as a whole, and may transmit/receive signals with the base station, other UEs, and other network entities. The signals transmitted/received with the base station may include control information and data. The transceiver 1610 may receive, for example, system information, synchronization signals, or reference signals from the base station. To this end, the transceiver 1610 may include an RF transmitter configured to up-convert and amplify the frequency of transmitted signals, an RF receiver configured to low-noise-amplify received signals and down-convert the frequency thereof, and the like. However, this is only an embodiment of the transceiver 1610, and the components of the transceiver 1610 are not limited to the RF transmitter and the RF receiver. Also, the transceiver 1610 may include wired/wireless transceivers, and may various components for transmitting/receiving signals. In addition, the transceiver 1610 may receive signals through a radio channel, output the same to the controller 1620, and transmit signals output from the controller 1620 through the radio channel. Furthermore, the transceiver 1610 may receive communication signals, output same to a processor, and transmit signals output from the processor to a network entity through a wired/wireless network.

The storage 1630 may store programs and data necessary for operations of the UE. In addition, the storage 1630 may store control information or data included in signals acquired by the UE. The memory 1630 may include storage media such as a ROM, a RAM, a hard disk, a CD-ROM, and a DVD, or a combination of storage media.

As used herein, the controller 1620 may be defined as a circuit, an application specific integrated circuit, or at least one processor. The processor may include a communication processor (CP) which performs control for communication and an application processor (AP) which controls upper layers such as application programs. The controller 1620 may control the overall operation of the UE according to the embodiments proposed in the disclosure. For example, the controller 1620 may control signal flows between the respective blocks to perform operations according to the above-described flowcharts.

When implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. An operation method of a terminal supporting an energy saving mode of a base station in a wireless communication system, the method comprising:
receiving, from the base station, a radio resource control (RRC) message comprising configuration information regarding energy saving of the base station;
receiving, from the base station, an indicator indicating activation or deactivation of the energy saving mode; and
performing communication with the base station based on the configuration information and the indicator;
wherein, in a case that the indicator indicates activation of the energy saving mode, a part of a transmission or reception operation of the terminal is not performed.

17. The method of claim 16, wherein, in a case that the indicator indicates activation of the energy saving mode, uplink transmission based on an uplink configured grant (CG) is not performed.

18. The method of claim 16, wherein, in a case that the indicator indicates activation of the energy saving mode, downlink data based on a semi-persistent scheduling (SPS) is not received.

19. The method of claim 16, wherein the configuration information includes at least one of an energy saving period or on duration time.

20. The method of claim 16, wherein the indicator is received from the base station via downlink control information (DCI).

21. An operation method of a base station operating in an energy saving mode in a wireless communication system, the method comprising:
transmitting, to a terminal, a radio resource control (RRC) message comprising configuration information regarding energy saving of the base station; and
transmitting, to the terminal, an indicator indicating activation or deactivation of the energy saving mode;
determining activation or deactivation of the energy saving mode, based on the configuration information and the indicator; and
performing communication with the terminal based on the configuration information and the indicator;
wherein, in a case that the indicator indicates activation of the energy saving mode, a part of a transmission or reception operation of the base station is not performed.

22. The method of claim 21, wherein, in a case that the indicator indicates activation of the energy saving mode, uplink transmission based on an uplink configured grant (CG) is not performed.

23. The method of claim 21, wherein, in a case that the indicator indicates activation of the energy saving mode, downlink data based on a semi-persistent scheduling (SPS) is not transmitted.

24. The method of claim 21, wherein the configuration information includes at least one of an energy saving period or on duration time.

25. The method of claim 21, wherein the indicator is transmitted via downlink control information (DCI).

26. A terminal supporting an energy saving mode of a base station in a wireless communication system, the terminal comprising:
a transceiver; and
at least one processor coupled to the transceiver,
wherein the processor is configured to
receive, from the base station, a radio resource control (RRC) message comprising configuration information regarding energy saving of the base station,
receive, from the base station, an indicator indicating activation or deactivation of the energy saving mode, and
perform communication with the base station based on the configuration information and the indicator, and
wherein, in a case that the indicator indicates activation of the energy saving mode, a part of a transmission or reception operation of the terminal is not performed.

27. The terminal of claim 26, wherein, in a case that the indicator indicates activation of the energy saving mode, uplink transmission based on an uplink configured grant (CG) is not performed.

28. The terminal of claim 26, wherein, in a case that the indicator indicates activation of the energy saving mode, downlink data based on a semi-persistent scheduling (SPS) is not received.

29. The terminal of claim 26, wherein the configuration information includes at least one of an energy saving period or on duration time.

30. A base station operating in an energy saving mode in a wireless communication system, the base station comprising:
a transceiver; and
at least one processor coupled to the transceiver,
wherein the at least one processor is configured to
transmit, to a terminal, a radio resource control (RRC) message comprising configuration information regarding energy saving of the base station,
transmit, to the terminal, an indicator indicating activation or deactivation of the energy saving mode,
determine activation or deactivation of the energy saving mode, based on the configuration information and the indicator, and
perform communication with the terminal based on the configuration information and the indicator, and
wherein a part of a transmission or reception operation of the base station is not performed in case that the indicator indicates activation of energy saving mode.
